(19) United States
(12) Patent Application Publication
(10) Pub. No.: US 2019/0087554 A1
(43) Pub. Date: Mar. 21, 2019

(54) A MOBILE DEVICE AND METHOD PROVIDING SECURE DATA ACCESS, MANAGEMENT AND STORAGE OF MASS PERSONAL DATA

(71) Applicant: OS-NEW HORIZONS PERSONAL COMPUTING SOLUTIONS LTD., Lod (IL)

(72) Inventors: Gila FISH, Mevasseret Zion (IL); Avner KORMAN, Herzlia (IL); David FREIDENBERG, Raanana (IL)

(21) Appl. No.: 15/765,687

(22) PCT Filed: Oct. 6, 2016
(86) PCT No.: PCT/IB16/55983

§ 371 Date: Apr. 3, 2018

Related U.S. Application Data
(60) Provisional application No. 62/237,682, filed on Oct. 6, 2015.

(51) Int. Cl. G06F 21/32; H04M 1/725; H04W 12/00; H04B 1/3888

(52) U.S. Cl. CPC G06F 21/32; H04M 1/72577; H04W 12/06; H04W 12/0051; H04B 1/3888; H04W 12/002

(57) ABSTRACT

A mobile device, a method and a system are provided as the invention personal mobile based enhanced secured data management and storage integrated platform solution. The integrated platform is in the shape of an add-on electronic sleeve/case fitted to fully integrate to a single handheld unit with the user's smartphone or palm device. That is enabling secured user private related data use, storage and management of data that is received through the user personal mobile communication device. The invention combined smartphone and smart electronic add-on case that becomes a one unit device, is enabling highly secured personal data updating and storage on the user's invention mobile add on case device while avoiding none legitimate users access to the secured device's storage content. The invention mobile device secured access it done by user's bio-authentication, that is based on the combined output of at least one human biological and physiological sensors and their weighted combined output analysis, done internally within the invention device internal signal processing resources. The invention device biological sensors are enabling controlled bio-authentication device memory entry only for the legitimate registered user of the mobile device. In case of authentication success it activates various types of applications while the user is operating and freely using his private data resources and services. In another embodiment of the invention the integrated mobile platform is being implemented as a vehicular secured and personal access key a personal safe motor ignition key and serving as a secured access to the vehicle internal computers and electronic control units.

### FIELD OF THE INVENTION

The present invention relates to upgrading the security, the privacy management and the improved handling of users' sensitive data and its use through modern mobile devices and for enhancing the operational capabilities and functionality of modem computerized mobile communication devices.

### BACKGROUND OF THE INVENTION

This disclosure relates to the field of wireless mobile telecommunications and more particularly to new mobile devices geared for extending the functional and security management performance capability of modern cell phones, preferably Smartphones.

Since the advent of mobile computing and cellular communication, efforts have been made to improve the ease of use and enhance the communication security with which portable electronic devices may be used, the speeds at which portable electronic devices operate and the availability and quality of wireless voice and mobile data network services, as well as to expand the functionality of portable electronic devices.

The frequency with which portable electronic devices are used, the circumstances and locations where portable electronic devices are used, are ever-increasing. In fact, users who carry portable electronic devices often access them and use them for voice communication and for various formats of data exchange in a plurality of times throughout each day and at multiple locations.

The portability of state-of-the art electronic devices that are configured for use in mobile computing has largely been made possible by advances in technology that enable all of the components of a portable electronic device to be assembled into relatively small, lightweight packages. Many portable electronic devices, such as so-called “smart phones,” are configured to be carried in a pocket of an individual's clothing, in a carrying case, or in a handbag, backpack or the like.

Other mobile computing devices, such as so-called “tablet” or “slate” computers, are also configured to be flat, light in weight and carried within carrying cases, folios, handbags, backpacks or the like.

Because of the small sizes of state-of-the-art portable electronic devices, the user interface features that enable an individual to enter information into the device are also relatively small. For example, some mobile computing devices include small dedicated input devices, such as flat keyboards and the like. Regardless of their size, however, small dedicated input devices consume valuable space, decreasing the available display area of an electronic device or adding to the thickness of the electronic device. Furthermore, the smaller the input device, the more difficult it is to use, which may decrease the speed with which an individual may use the input device.

To reduce the risks of unauthorized use of the device's communication services and/or unauthorized access to stored data, most portable communication devices include a password or a PIN number based protection system. A typical password protection system is implemented by disabling the keypad, or the telephone circuits, and/or access to the specific installed data application, all blocked unless and until the user enters an applicable unlock code. Generally the password/unlock code is in the form of alpha numeric text which may be entered using the keypad of the mobile electronic device.

There exist several challenges with such alphanumeric password/unlock code protection systems. First, the protection provided by a password only exists so long as the password is not compromised. Many people tend to use passwords that are easily guessed, or write their passwords on paper, and otherwise compromise the integrity of their passwords, this has been frequently mal-used by hackers. Second, user entry of a password (and the associated key strokes needed to reach the password entry prompt and active the electronic device after password entry) can be hard to recall and also time consuming and aggravating—to the point where many people select the option of disabling the password protection of the mobile electronic device and their content.

An alternative system used to password protect a mobile telephone is disclosed in U.S. Pat. No. 6,351,634 to Shin. The system of Shin is useful for a mobile telephone that includes a touch screen. A registered secret symbol is used as the password. The secret symbol comprises a stroke number value responsive to the existence of pressure applied to the touch screen and X/Y coordinate values for each stroke. In operation, a user inputs a symbol using the pressure sensitive touch screen to draw the various strokes of the secret symbol. The device determines whether the input symbol matches the registered secret symbol and unlocks the telephone if the character stroke number value and the X/Y coordinate value signals match that of the secret password symbol. Shin teaches that the secret password symbol can be a character, a signature, a numeral, or a combination thereof. A significant challenge of the system of Shin is that so long as someone can duplicate the secret password symbol, whether by tracing the user's code insertion acts or by careful drawing possible variations on the touch screen, such person has access to the mobile telephone. Stated another way, authentication of the user is based on the user being able to duplicate the strokes and shape of the secret password symbol,

The aim of a biometric system or mobile integrated module is the realization of the identification/authentication of people using some biological characteristic or physically measured behavior of the individual, in a safe and non-invasive way. The problem of identification and authentication of people is very old and has always tried in the past to be solved with different media: private/personal seals, titles, stamps, nameplates, etc. Today this is not enough and you need to introduce new legitimate user authentication and identification techniques to ensure that a person is who they say they are in many contexts.

There are many biometric techniques that try to recognize a person by their physical characteristics (iris, face morphology, fingerprint, voice recognition, etc.) or their behavior (gait, air gesture, manner of writing, online signature, etc.). It is vital in this document, by its similarity, to implement signature by a biometric technique online. Many works have been developed to improve this technique. They explain the basis for online signature verification. In this type of biometric identification testing, it is compared while the user is drawing on the screen to be matching to the one stored, and that the way to make such signature matches to what was done and recorded in the initial registration procedure by the registered user. To this end, various parameters are measured when making a signature, such as writing speed, pressure or angle of the pen at each point in time when the signature is done, among other features. These signatures can be performed in a special screen that collects and analyzes all necessary signals for analysis or on paper if the pen with which the firm is able to measure the signals described above and send them to a server where you perform the analysis and the signature verification.

In patent MX2007007539 collects a system implementing the biometric authentication using an electronic signature. This system includes an interface to a computer capable of storing the movement of a cursor on a computer screen and compared with already stored signature patterns.

The first object of the present invention relates to performing a highly reliable and unique user's authentication capability in a mobile device. Today, there are many applications, especially while aiming at the BYOD related applications of the user communicating with his employer enterprise IT resources that can be accessed from a mobile terminal, where it is necessary and even critical in many implementations to positively and reliably identify the legitimate user. For years the entrusted all security user's identification on mobile devices are based on a simple solution, that is to type a secret key (PIN) on the phone keypad that the user knew. However, these keys can be easily forgotten, transferred, lost or even counterfeit, so that user authentication is highly compromised. Focusing on the advanced and more secured biometric technique to authenticate a user with a mobile device, are found in US2006286969 and in US2008005575.

In US2006286969 it is proposed to have a remote authentication scheme to authenticate users from a mobile device. The biometric technique used is the voice recognition. The system consists of a mobile phone to send voice samples of an authentication device that connects to a database that stores the identities of mobile phones and voice pattern associated with that phone to make a comparison and check the user is talking on the phone is registered in the system. US2008005575 proposes a method and integrated personal electronic device for authenticating a user on a mobile phone. While the user holds the phone to his ear, a microphone emits a signal near the user's ear and the speaker phone is able to measure the ear's response to this signal. A processor analyzes the response signal and converts it into a signature that uniquely identifies each person and can be used to authenticate.

Alternatively various bio-authentication techniques are known as gesture recognition, in which a system is able to detect when a user makes a certain known gesture. Found US2009103780 and WO2009006173 patents related to methods to recognize standard gestures. Patent US2009103780 includes a method for collecting the gestures produced by hand, based on light hand at first by the palm and the back, to get your silhouette associated from various lighting infrared, it proposes a method for collecting various hand movements and identifying a series of gestures previously stored in a database of gestures.

WO2009006173 patent describes a method for detecting the response of an electronically gesture of a user while listening to a speaker using a mobile device, when performing a specific gesture. Related to the idea of recognition of a person by making a gesture is found the patent WO2007134433. It develops a method to authenticate a user when performing an action that manual manipulation of a device such as a mouse. Authentication is to obtain the gesture with the mouse by the user when chasing a target and compare it to the stored pattern of the user when that objective has been pursued previously.

Regarding the use of accelerometers in mobile devices, there US2005226468 authentication systems proposed to authenticate the user based on certain biometric sensors must be connected to the mobile device, and verifies that the authentication was successful based on a accelerometer that collects data on how to get the user's device, ensuring it is not a machine trying to cheat the system.

Also, in US2009030350 discloses a method and a system for analyzing patterns gaits of a subject by measuring the acceleration of the head in the vertical direction while walking, It uses an accelerometer that is placed on the user's head. The analysis includes the creation of a signature from the acceleration data when a user walks. In another invention the prior art also proposes the use of the patterns obtained by realizing the user gesture for generation or release of a cryptographic key. In this connection, patents found DE102005010698 and KR749380-B1. DE102005010698 describes the construction of a cryptographic key for secure communication independent from the fingerprint. It proposes to use that key to communication demand TV with pay per view applications, child protection or age verification.

KR749380-B1 describes a method to generate a key from a biometric characteristic that does not change with time as the iris. The biometric information is received and preprocessed, extracted some values and associated cryptographic key is obtained by grouping the values, The clustering error is corrected using a block of Reed-Solomon code. The obtained key can be applied to any cryptographic system.

US 20140357227 A1 is a smart phone server sleeve/case under a US patent pending application from Jun. 3, 2013, by R. M. Lee, it describes a phone external sleeve/case device that acts as a server, In one embodiment, the sleeve/case may be configured to attach to a mobile device. The sleeve/case may include a server configured to only wirelessly connect to the mobile device. The sleeve/case comprises a server is configured to only wirelessly connect to, and provide a secure and trusted environment for the mobile device. A major part of the claims in this US patent application and the applicable functional element that describes new uses in said invention, are covered by the present invention prior art relevant registered patent U.S. Pat. No. 8,401,875 B2 that was published 15 Sep. 2011 and filed by the same applicants of the present invention, This patent deals with a system, method and personal apparatus for managing highly secured personal data. The invention apparatus is managing personal and secured data and documentation files stored in the apparatus, the apparatus has communication and data connection means in communication with the apparatus internal processing module for connecting the apparatus with an external device, said external device may be a cell phone.

Consequently, it is desirable to have a highly reliable and secured mobile platform geared for best and highly secured private data storage and use that will be securely highly protected, enabling safe access to the user's data, yet in some cases also there is a need to connect and exchange data with his enterprise IT resources. Secured data access enterprise operation is enabled through a device integrated user recognition and authentication module, as will be further described in the present invention. The invention solution should avoid the drawbacks existing in the presently known BYOD (Bring Your Own Device), that is targeting the user's private smartphone work oriented secured use and management methods, and the configuration of the related mobile devices and systems, representing the present state of the art. The present invention solution should perform a different hardware based solution that includes the user biometric authentication process, which brings and combines together the two general characteristics of biometric authentication: the phone/device owner physical characteristics and behavior.

Recently there is a new trend surfacing that may start to replace BYOD in the coming years. Corporately Owned, Personally Enabled (COPE) devices are the next big thing that within the coming years, some projections indicate 70 percent of global organizations will adopt it. BYOD is a concept that was floated first in Asia, but also recently realize it is hard to manage implications, such as: challenges in securing corporate data, an increased need for IT resources and support, increased costs, difficulty maintaining network performance, and challenges in managing a high multiple plurality of different user chosen devices and related required applications. Companies like BlackBerry, which was ahead of the curve in adopting BYOD, were also the first to try out COPE pilots, where the goal was essentially to show customers this model was a better, less risk-laden option for enterprise mobility than is BYOD.

The biggest difference between BYOD and COPE is the management of personal data on the device. Employees own their devices with BYOD, hence Bring Your Own, which gives organizations less control over how they are being used. It goes without saying that this leads to massive potential for security issues. It also puts an organization in peril, especially with the sales force owning their own phone numbers. With COPE, the end user has more flexibility in choosing a mobile out of an employer offered reasonable selection, but the organization still has better and reasonable control over costs, security, and other areas of potential risk such as legal and HR implications. This gives employees/professionals personalization options, while also minimizing the need for IT to manage an overwhelmingly mixed range of devices. COPE also gives organizations the power to monitor policies and devices, beyond simply selecting which ones can be distributed. If the device is stolen, the company can send a wipe command. Organizations can also conduct automatic checks on malware and dangerous applications, sending warnings about certain apps to the device owner in order to proactively avoid potential security threatening issues.

There are more hidden costs associated with BYOD than with COPE; costs to look out and get data to include device management and maintenance, personal service partitioning and impacts, and migration expenses, among other things. So while today BYOD continues to dominate enterprise mobility discussions, COPE is phasing it out, as more organizations realize the benefits and flexibility that can be achieved through the COPE alternative model that will be well fitting the vision of use of the present inventions devices.

Therefore there is also a need in the art for advanced computerized phones and tablets users to have an easy way and a workable solution to have and use a more secured mobile communication device that includes modules and methods for enabling the growing combined demands of high capacity secured data storage and management reliability, improved data storage security and secured communication between the user and his Enterprise IT resources, while enduring the overall operational ease of use, including new ways of critical required authenticating of the legitimate user of the mobile device. Non authentication should enable locking or unlocking the user's phone access to the remote organization/enterprise resources and to the user's internal mobile device secured data access functions, including the device's stored user's private sensitive data depository as well as of the enterprise the user work required for getting access to the organization related sensitive data, storage and access capabilities. In a case of negative or a positive user authentication, the needed new solution should not suffer from the disadvantages of implementing present art traditional characters strings based password protection solutions and of present art other heavy security oriented data encapsulation solutions based on installed large SW files managing on the mobile phones internal memory wherein the Enterprise resources access is managed through those SW separation solutions, thus limiting the mobile communication device to much slower and reduced performance disadvantages known to those skilled with present art as SW based BYOD and COPE SW adapted mobile devices and the related supported systems.

Regarding to terminology used in this document portable communication equipment, also referred to herein as a “mobile radio device or terminal”, includes all equipment such as mobile phones, pagers, communicators, Notepads Notebooks and alike, e.g., electronic organizers, personal digital assistants (PDAs), Smartphones or the like. It should also be appreciated that many of the elements discussed in this specification, whether referred to as a “system” a “module” a “circuit” or similar, may be implemented in hardware (circuits), or a processor executing software code, or a combination of a hardware circuit and a processor executing code. As such, the term circuit as used throughout this specification is intended to encompass a hardware circuit (whether discrete elements or an integrated circuit block), a processor executing code, or a combination of a hardware circuit and a processor executing code, or other combinations of the above known to those skilled in the art.

### SUMMARY OF THE INVENTION

The following embodiments and aspects thereof are described and illustrated in conjunction with devices, methods and systems, which are meant to be exemplary and illustrative, not limiting in scope. In various embodiments, one or more of the above-described limitations and emerging modern user's growing mobile devices daily secured data use needs, have been solved, reduced or eliminated, while other embodiments are directed to other advantageous or improvements of securely managing a modern user personal and private data depository.

The core of the present invention is an advanced and highly reliable new approach to have and manage user's private personal data depository storage on the present inventions secured mobile devices and on solutions to highly protecting the invention mobile device stored medical depository against intruders, hackers and mal use. The Invention deals with adding and integrating to modern voice and data communication devices, such as Smartphones and palm communication devices, with an external mobile additional secured mobile data storage and management packaged electronic unit, functioning as an add-on sleeve/case computerized device. The invention also deals with ways to improve secured user's data access and management, while supporting the improved security needs for the execution of a mandatory personal and highly secured preliminary and legitimate user's authentication stage. The invention relates in particular to the need of integration to conventional mobile communication devices with add-on based computerized authentication and secured data storage and management devices, and their secured operational methods, serving private user data management and for improved and advanced automotive vehicle management applications. The field of the invention also relates to supporting the user's improved and highly reliable authentication, while blocking the access of any non-legitimate user to the user's private secured data depository residing on the present invention advanced user's mobile device. In addition the invention also deals with physical and mechanical damage protection of portable electronic devices through the integration of a high endurance mechanical protection sleeve/case, containing the enhanced data secured management electronic modules.

The present invention also relates to upgrading the security and privacy management of mobile user's sensitive data handling and for improving and enhancing the operational capabilities and functionality of modern computerized mobile communication devices. More particularly the Invention deals with adding and integrating to present art mobile voice and data communication devices, such as Smartphones and palm size tablet communication devices, with an additional secured mobile data storage and management add-on sleeve/case structure packaged electronics computerized device. The add-on sleeve/case invention device is managed by a set of dedicated software secured access applications that are resident on the user's smartphone. These secured applications are dedicated to securely operate, manage and store user's personal life management data on the inventions device. The stored data is always encrypted yet readily available to be easily accessed by the user and then when required is decrypted to be displayed and used by the user through the integrated user's mobile electronic computerized communication devices display and data I/O capabilities. The invention also deals with ways to improve user's sensitive and protected data access and management security and privacy, by enabling the execution of a mandatory user's personal and highly secured preliminary and legitimate authentication stage. The invention relates in particular to the need of integration of conventional mobile data and voice communication devices with dedicated add-on based computerized authentication and secured data storage hardware devices, and their secured operational method. The invention enhanced security features relates also to supporting the user's improved and highly reliable authentication, while blocking the access to the secured stored data of any non-legitimate user avoiding any hacker from access or mal-use of the user's private secured data depository, residing on the user's mobile device. In addition the invention also deals with physical and mechanical damage protection of portable electronic devices.

In a more general sense the invention relates to new add-on accessories for mobile electronic devices that are integrated with components that enhances or supplement the functionality, performance, or security of present art mobile computerized electronic devices.

The core of the present invention is an advanced and highly reliable new approach to have and manage an isolated secured computerized platform to be used in conjunction and in tandem with the mobile communication device of the user for separately and securely running and managing user's privacy related applications/programs. The present invention device is created by the preferred embodiment of a wired connection, or alternatives short range wireless connection and integration to the user smartphone of an the invention attachable smart electronic mechanically packaged sleeve/case shaped case attached and electronically securely connected to the user's mobile phone, said sleeve/case contains at least a CPU, a large storage capacity SD flash based memory card, a power rechargeable battery module, a plurality of biometric sensors and wired digital data communication means to exchange data with the user mobile phone. Optional in additional invention embodiments are the invention electronic sleeve/case additional internal physiological sensors to sense the liveness and emotional state of the user and a NFC or Bluetooth short distance wireless communication module. With the invention device the users are authenticated for content entry permission by using advanced biometric identification techniques and algorithms that are smartly combining the output of one or more said sensors processed output results. In addition, the invention electronic sleeve/case when including a Near Field Communication (NFC), or a Bluetooth wireless communication module can be used and implemented as personal bio-identification based device, supporting user's biometric authentication based applications, that are related to the invention device use as secured physical access gate control.

The present invention one preferred embodiment of a secured mobile device is an integrated secured personal mobile electronic device for communicating, storing managing and updating all user's private life daily privacy sensitive data or private sensitive operations, the invention device is comprising: a. a mobile communication device equipped with a CPU, a display unit, one or more biometric sensors, a rechargeable power battery module and a cellular modem to enable data communication over the cellular and internet networks equipped to receive and send user's private data with a plurality of data sources; b. an electronic physical protection sleeve/case, shaped as an add-on device, attached and fits to said mobile communication device external back side perimeter, made to create together with said communication device a unified user carried single device, the sleeve/case contains at least one CPU, a solid state large storage capacity secured memory module equipped to encrypt/decrypt, store and manage the user's private and personal data, the mobile secured communication device is also containing a biometric sensors module, a RAM unit, a rechargeable power supply battery module and data communication wired and wireless means to enable connection and data exchange between the mobile communication device and the electronic sleeve/case; c. wherein; the add-on device biometric sensors module comprised of a set of at least one biometric measuring parameter sensor, each of the at least one sensors is measuring and generating a different user's characterizing biometric parameter; d. wherein in response to the measured output of any combination of said add-on sleeve/case biometric sensors module and one or more biometric sensors of said mobile communication device user's personal measured and sampled biometric output signal, a user's authentication analysis process is executed by at least one of said integrated secured mobile personal electronic device CPU units, while said user's authentication is based on said at least one user's measured biologic sensors output signal processing results and their comparison to the reference pre-recorded securely stored user's measured biologic sensors initial device enrollment stage measurement output ; and e. only when such authentication process results are positive the add-on secured electronic sleeve/case is creating a direct two-way secured data communication and data exchange channel with the mobile communication device.

In another embodiment of the present invention the integrated mobile personal electronic device further include: a. a set of user's private data management related functions activation and operation is executed when a user sampled biometric data sequence of the user measured at least one biometric parameter is compared for good matching by the add-on sleeve/case CPU to similar prerecorded and stored data on the sleeve/case memory containing a set of sampled device reference legitimate registered user's biometric initial enrollment stage measured data; b. wherein the prerecorded sampled biometric reference data is recorded upon the legitimate user executing on the mobile electronic device an initial supervisor controlled registration enrollment procedure, enabled by the at least one biometric sensors output while being recorded and securely stored on the electronic sleeve/case memory for further authentications; c. wherein the related set of user's private data management functions is positively activated and the device sleeve/case secured memory is unlocked and ready for use, only for a pre-defined time duration when said electronic sleeve/case operated by a legitimate mobile device user is activating said at least one measured user's biometric sensors and said at least new sensor output data is being positively compared with said legitimate user pre-recorded registration procedure reference data, and said two sets of sensors' output data deviates from each other by less than a predetermined minimal threshold; and d. wherein said mobile personal electronic device further containing a touch screen display unit for display of data to the user and indicating the device status and for the user's interaction with data content of the mobile electronic device communicating with the user remote data suppliers

In another embodiment of the present invention in the invention integrated mobile personal electronic device, at least one of the at least one biometric sensors is a life signs detector, the life signs detector being configured to measure and record at least one of said user's life sign parameters.

In yet another embodiment of the preset invention integrated mobile personal electronic device, at least two measuring biological sensors are selected from two sensors group including one sensor selected from the first group comprising from at least: a three dimensional device air-gesture linear acceleration based measuring sensor, a three dimensional mobile device air-gesture angular movement tilt measuring sensor, a fingerprint pattern sensor, a face recognition imaging sensor, a palm pattern and morphology and palm veins IR imaged veins networks combined measuring and analysis IR/visible imaging sensor, user's voice analysis based on a voice pickup microphone sensor and a second sensors group comprising of at least one user's life signs indicating sensor selected from the physiological parameters measuring sensors group comprising of at least the user's heart bit rate, blood oxygen content, body temperature, EKG and user's skin conductance.

In another embodiment of the present invention secured mobile personal electronic device, the digital output of one of the at least one biometric sensors user's biological parameter measurement results and the measured at least one additional biometric sensor output results, are fused together by using a learning and adaptable dynamically weighted factor fusion algorithm, done between the two sensors measured output, in order to enable improved and precise analysis and identification of the legitimate user exact typical personal characteristics and wherein the algorithm is creating a highly reliable user's authentication mechanism to best authenticate, while comparing to a similar reference initial enrollment stage the prerecorded fused set of the two kinds of sampled user's biometric sensors, for deciding if to activate the internal sleeve/case operation for enabling user's access to the sleeve/case secured memory content.

The following embodiments and aspects thereof are described and illustrated in conjunction with devices, methods and systems, which are meant to be exemplary and illustrative, not limiting in scope. In various embodiments, one or more of the above-described limitations and emerging modern user's growing mobile devices daily secured use needs, have been solved, reduced or eliminated, while other embodiments are directed to other advantageous or improvements of securely managing a modern user personal and private data depository and also managing the user's vehicle automotive daily advanced modes of operation and the vehicle maintenance data depository.

One of the main objects of the present invention proposes the creation of a positive and highly reliable and further secured user's authentication by implementing an advanced more than one biometric measured parameters fusion by an advanced algorithm through a dedicated computer SW embedded within the invention electronic sleeve/care device that is processing the measured outputs of at least one biological sensors and measuring their output in tandem as the user's more reliable combined authentication means.

Two of the preferred embodiments of the present invention biometric identification and authentication means and methods may be the imaging and analyzing the user's face recognition and by imaging and analyzing the image of the user's hand palm and the 5 fingers morphological pattern, in another novel embodiment of the present invention the image of the palm may include also the veins and minor blood vessels seen on the palm surface image while imaging the palm with an IR sensitive camera sensor and illuminating the palm with an near IR illumination source such as a high intensity IR LED.

A first aspect of the present invention devise comprises a mobile electronic device which enables a user to authenticate himself through the parallel in tandem operation of the present invention mobile electronic device internal integrated set of at least one or more biological sensors capabilities and then to enable a function of the mobile electronic device using its internal CPU module to differentiate between the authenticated legitimate user and a none authenticated none legitimate user by analyzing and detecting the users personal unique biometric sensors output measurement, such as the user's face pattern image, the user palm and fingers image analysis, or the user voice.

Another possible embodiment of the present invention, is demonstrated wherein the invention mobile device is used for a multiple digital functions vehicular implementation, serving the needs of advanced security, better operation and ease of use for the modern automotive and cars industry. For this embodiment it is also needed to have an additional special in-vehicle anchoring smart docking station, that is added and installed into the car dashboard or the driver's car front control panel, while serving the needs of functioning as the user's invention combined smartphone and device authentication function execution and supporting the need to have the wired highly secured communication solution needs with the car computing and control integral modules. In parallel the present invention embodiment smart docking station will be serving also as a power battery charger for both the present invention combined mobile device sleeve/case and smartphone separated units.

The automotive enterprise industry world is recently going through major changes related to the in-vehicular related implementation and integration of mobile devices namely Smartphones and tablets. The popularity of those devices and their use for many personal and professional applications is fast growing and expanding while their increased operational and technical capabilities may lead for the in-vehicle automotive use of personal mobile devices as an access point to the modern vehicles integrated electronic controls and in vehicle functional management computers and in parallel also in providing access to remote data communication servers, connecting the vehicle to the automotive manufacturing and maintenance enterprise and its remote IT resources, enabling these capabilities with both the local vehicle manufacturer certified maintenance garage, as well as with the manufacturer remote central management IT resources.

In the present art the Bring Your On Device solutions concepts are based on the technical solutions wherein smart-mobile devices are being used by enterprise employees, both for their personal use and for organizational secured communication, supporting the private needs of the device user versus the remote enterprise user work related data exchange use needs. The present art integrated SW based security solutions on the BYOD employee's mobile phone must keep a balance between security and the user's usability. This balance leads to security compromises which might affect the entire enterprise network security.

In the present invention a similar dual use concept is used and securely implemented for supporting secured data communication between the invention user's secured communication devise and his vehicle integral control computers. In parallel the present invention secured device is enabling also two-way secured data connection with the automotive enterprise remote maintenance and vehicular management updating IT resources. The present invention integrated secured mobile personal electronic device and its related based cellular and Internet communication capabilities with the user's vehicle automotive enterprise IT resources, are connected to the in-vehicle electronics through an additional secure docking module, that is integrated to the vehicle dashboard. This dedicated vehicular combination of the secure docking module with the invention Secured mobile device is offering therefore a new secure in vehicle data management solution, based on a separate and highly secured vehicular management data storage and communication management, enabled through the present invention integrated secured mobile personal electronic device capabilities. The invention device enables also secured remote cellular infrastructure based data communication and secured text messages features, securely managing sensitive messages exchange and communication between the vehicle authorized user and the automotive enterprise remote maintenance data updating resources, coming from and through the automotive enterprise remote text messages servers. It provides for the enterprise sensitive maintenance data management and exchange requirements the capability to connect and send updated data whenever needed with the remote plurality of on-road and under maintenance vehicles.

The invention combined communication phone and the secured data management and storage created by the invention attached smart sleeve/case, is creating a fully managed and secured integrated new in-vehicle car integrated device having its own encryption capabilities, highly protected encryption keys and an operating system invention devise with an automotive dedicated highly secured internal data storage partition. The invention combined device provides the protection required for sensitive vehicle maintenance management, by related vehicle documents storage and their updating management on the present invention secured mobile device memory, thus securely managing and storing valuable automotive corporate IP and commercial data assets. The invention combined device and related invention enhanced automotive maintenance related combined hardware and SW based vehicular management system, are also capable for storing and protecting the vehicular maintenance history (vehicle log-book), as well as running the automotive enterprise applications, all in a highly protected and isolated environment.

Another possible embodiment of the present invention, is demonstrated wherein the invention mobile device is used for a multiple digital functions vehicular implementation, serving the needs of advanced security, better operation and ease of use for the modern automotive and cars industry. For this embodiment it is also needed to have an additional special in-vehicle anchoring smart docking station, that is added and installed into the car dashboard or the driver's car front control panel, while serving the needs of functioning as the users invention combined smartphone and device authentication function execution and supporting the need to have the wired highly secured communication solution needs with the car computing and control integral modules. In parallel the present invention embodiment smart docking station will be serving also as a power battery charger for both the present invention combined mobile device sleeve/case and smartphone separated units.

The present invention advanced users authentication biometry makes sure that only authorized vehicle users should be able to have access to the secured vehicle maintenance management related data and its management therefore avoiding vehicle thefts by unauthorized users. The present invention combined secured communication device and system is planned to be part of the automotive organization IT management system, while in parallel still keeping the users' private mobile free for the user's daily normal use without any restrictions.

In one preferred embodiment of the present invention automotive enterprise proprietary and sensitive vehicular data depository storage on the present inventions integrated secured mobile personal electronic device, creates the need to highly protecting the invention mobile device stored vehicle maintenance data depository against intruders, hackers and mal use. The invention device has therefore an integrated highly reliable authentication module, analyzing the user's identity through at least one biometric sensors measured output, when user's authentication is done while the user is holding the mobile device and operating in tandem the biometric sensors measurement on his relevant human body parts,

The invention secured person& mobile electronic device is further adapted to user operation with the device in a user associated vehicle environment for enabling and supporting the technical needs of secured communication from the invention device to the user vehicle integrated automotive computer and the electronic control units and in parallel enabling secured data communication with the vehicle remote automotive enterprise IT resources, the user associated vehicle environment is further comprising; a. an additional special in-vehicle electronic smart docking station adapted for operating with said invention secured personal mobile electronic device by its insertion into said car anchoring secured docking station module, said docking station mechanically integrated with or into the vehicle dashboard or to the vehicle deriver's control panel; b. said vehicle integrated secured docking station acting a s security smart electronic data buffer between said user secured personal mobile device and said user vehicle computer and vehicular electronic control modules; c. upon positive authentication of the legitimate vehicle user by said secured personal mobile electronic device authentication module, only then data received from remote legitimate authenticated vehicle maintenance data resources and stored on said secured docking station memory module is then released for use by said smart docking station and transferred and exchanged through said vehicle integrated vehicular data bus with said vehicle computer and electronic control modules; d. upon positive authentication of the legitimate vehicle user by said secured personal mobile electronic device integral authentication module, only then data is received from, or transmitted to, between said personal mobile electronic device and said remote automotive enterprise IT resources all done through the data transfer security assurance control of said intermediate secured docking station; and e. said secured docking station serving in parallel as the battery charging power source for the two batteries modules integrated in both said s communication device and said add-on invention smart sleeve/case.

In yet another embodiment of the present invention there is provided a method for user interacting managing and updating data and associated documentation exchange for enabling user's local work with the user stored data resources the user having an integrated mobile personal electronic device including mobile communication means and an electronic sleeve/case shape add-on device uniquely associated with its single user, each of the integrated personal mobile electronic devices comprising: a. a mobile communication device equipped with a touch screen for user's interaction and a cellular modem to enable data communication over the cellular and internet networks equipped to receive and send user's vehicle related data to and from the user vehicle manufacturing enterprise IT management resourses; and

b. an electronic secured sleeve/case shaped as an add-on device, attached and fits to the mobile communication device external back side perimeter to create together with the communication device a unified user-carried single compact device, wherein the present invention electronic sleeve/case contains:

a biometric sensors module comprising at least one biometric set of sensors; a processing CPU module in communication with the sensor module; an authentication unit in communication with the CPU based processing module; an encryption module in communication with the processing module; a memory module in communication with the processing module and with said encryption module; and communication and data connection means in communication with the mobile communication device; the method comprising the steps of: a. the invention electronic sleeve/case biometric sensor module reading the at least one personal biological identification sensors output parameters of a user holding said mobile communication device; b. the invention electronic sleeve/case biometric sensor authentication module comparing the generated personal biological identification parameters of the user with a pre-recorded set of personal biological identification parameters stored in the invention electronic sleeve/case authentication unit; and c. if the authentication unit positively identifies the user, then allowing the user to get access to the user's personal data documentation and work files stored in the electronic sleeve/case memory module for is management updating and review and when required also allowing user during the user pre defined access allowance time duration to communicate and exchange files and data with the user's vehicle automotive enterprise IT requested or needed resources through the invention mobile electronic device communication capabilities.

Unless otherwise defined, all technical and/or scientific terms used herein have the same meaning as commonly understood by one of ordinary skill in the art to which the invention pertains. Although methods and systems similar or equivalent to those described herein can be used in the practice or testing of embodiments of the invention, exemplary methods and/or systems are described below. In case of conflict, the patent specification, including definitions, will control. In addition, the materials, methods, systems and examples herein are illustrative only and are not intended to be necessarily limiting.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art on how embodiments of the invention may be practiced. FIG. 1 is a schematic visual illustration of a schematic 3D layout of the typical present art dual use BYOD system comprised of multiple users' computerized devices, both mobile and stationary computerized devices, connected through security management envelops with the enterprise core internal IT management network.

FIG. 2 is an illustration of a schematic block diagram of one possible embodiment of the present invention mobile secured personal electronic device configuration, wherein it is created by a combined configuration comprising the invention electronic sleeve/case shape add-on device that includes a microprocessor module, a large storage capacity Flash memory, a user authentication module, an acceleration detectors module, a tilt detectors module, an audio microphone module, two cameras and related image processing module, It also demonstrates the attached second part of the present invention device, combining a mobile communication device that has a set of dedicated SW applications to run and manage the invention electronic sleeve/case shape add-on device, The mobile communication device includes also the invention personal electronic device implemented and used touch screen display unit and its touch screen interaction module, an RF cellular communication modem module and a GPS location module.

FIG. 3 is a schematic illustration of the present invention integrated mobile personal electronic device combined of the user mobile device and the invention electronic sleeve/case. The figure demonstrates the functional modules residing on each of the two present invention integrated mobile secured personal electronic device modules.

FIG. 4 is a schematic illustration that shows another preferred embodiment the main functional modules of the user's invention integrated secured mobile personal electronic device combined by the physical integration of a mobile device and the invention dedicated add-on electronic sleeve/case. This device is connecting through the cellular and internet managed cloud to the user vehicle manufacturer automotive IT management infrastructure.

FIG. 5 is a schematic block diagram illustration of one possible embodiment of the present invention modular layout of the functioning elements of the user invention integrated secured mobile personal electronic device with the vehicle computerized resources and the remote automotive enterprise maintenance and vehicular data updating servers.

### DETAILED DESCRIPTION OF THE INVENTION

The present invention, in some embodiments thereof, relates to mobile devices user's enhanced privacy and sensitive private data management and data storage applications and their enhanced use related solutions and, more particularly, but not exclusively, to methods, a device and a system to manage and conduct mobile devices legitimate user bio authentication based sensitive data access control and the creation and support of enhanced legitimate user data privacy and security management performance.

Before explaining some embodiments of the invention in details, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

As will be appreciated by one skilled in the art, aspects of the present invention may be embodied as a device, a system, and a method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, integrated personal electronic device, or device, or any suitable combination of the foregoing. More specific examples (a non-exhaustive list) of the computer readable storage medium would include the following: an electrical connection having one or more wires, a hard disk, a random access solid state memory (RAM), a read-only memory (ROM), an erasable programmable read-only memory (EPROM or Flash Memory), an optical fiber, an optical storage device, a magnetic storage device, or any suitable combination of the foregoing. In the context of this document, a computer readable storage medium may be any tangible medium that can contain, or store a program for use by or in connection with an instruction execution system, integrated personal electronic device, or device.

A computer readable signal medium may include a propagated data signal with computer readable program code embodied therein, for example, ire baseband or as part of a carrier wave. Such a propagated signal may take any of a variety of forms, including, but not limited to electronic, electro-magnetic, optical, or any suitable combination thereof. A computer readable signal medium may be any computer readable medium that is not a computer readable storage medium and that can communicate, propagate, or transport a program for use by or in connection with an instruction execution system, integrated personal electronic device, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's smartphone, partly on the user's smartphone, as a stand-alone software package on the user electronic sleeve/case shaped add-on computerized device, partly on the user's smartphone and partly on a remote computer, or entirely on the remote computer or server. In the latter scenario, the remote computer may be connected to the user's mobile device through any type of network, or the connection may be made to an external computer (for example, through the Internet using an Internet Service Provider, or through a cellular service provider).

Aspects of the present invention are described below with reference to flowchart illustrations and/or block diagrams of devices, methods, systems and computer program products according to different embodiments of the invention. It will be understood that each block of the flowchart illustrations and/or block diagrams, and combinations of blocks in the flowchart illustrations and/or bock diagrams, can be implemented by computer program instructions. These computer program instructions may be provided to a processor of a smartphone, on an electronic sleeve/case shaped smartphone add-on computerized device, a notepad, a laptop, a special purpose computer, or other programmable data processing integrated personal electronic device to produce a machine, such that the instructions, which execute via the processor of the computer or other programmable data processing integrated personal electronic device, create means for implementing the functions/acts specified in the flowchart and/or block diagram block or blocks.

These computer program instructions may also be stored in a computer readable medium that can direct a computer, other programmable data processing integrated personal electronic device, or other devices to function in a particular manner, such that the instructions stored in the computer readable medium produce an article of manufacture including instructions which implement the function/act specified in the flowchart and/or block diagram block or blocks,

The computer program instructions may also be loaded onto a smartphone a mobile or portable computerized device, other programmable data processing integrated personal electronic device, or other devices to cause a series of operational steps to be performed on the computer, other programmable integrated personal electronic device or other devices to produce a computer Implemented process such that the instructions which execute on the computer or other programmable integrated personal electronic device provide processes for implementing the functions/acts specified in the flowchart and/or block diagram block or blocks.

Reference is now made to FIG. 1, which is an general illustration of a visual structure of a schematic 3D layout of a typical present art bring-your-own-device system 100 comprised of a multiple users mobile devices computerized devices, with three typical types of mobile devices; smartphone, note-pad and laptop 101,102,103 and with additional various types of stationary computerized PC devices 104,105,106,107, all connected through security management envelops 110 with the enterprise security access protection layer 120 and through it to the enterprise IT management core 130, including the remote enterprise internal servers and IT management system, including also internal data communication network and the related two ways required data flow.

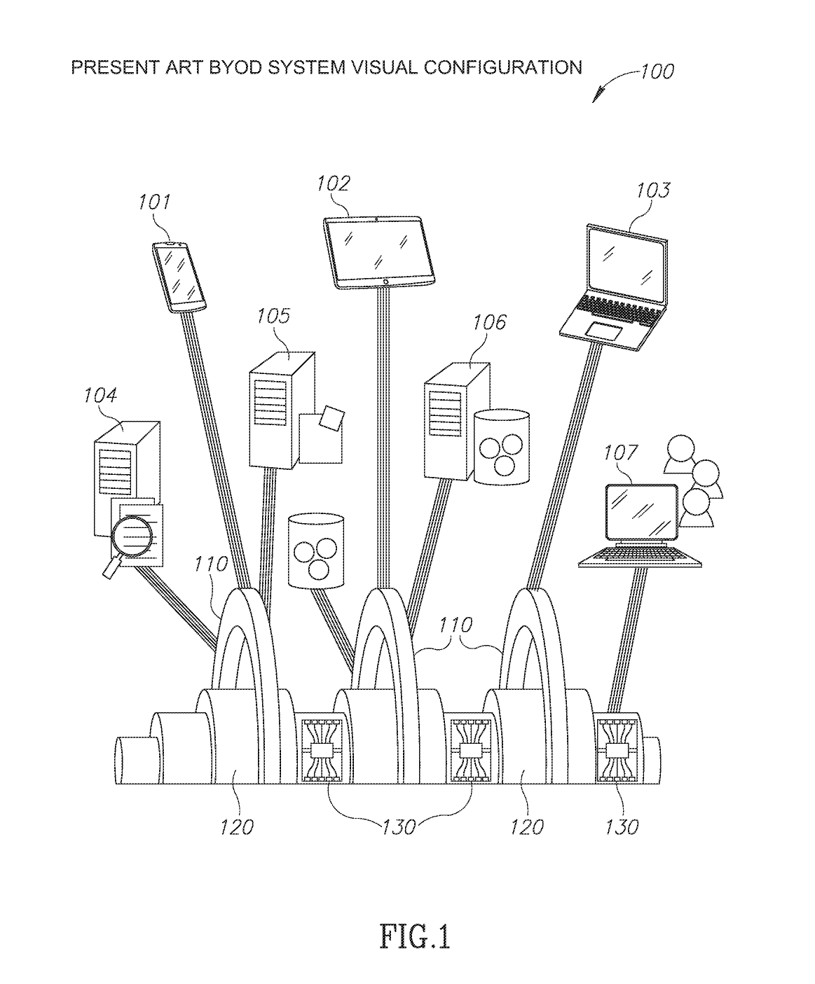

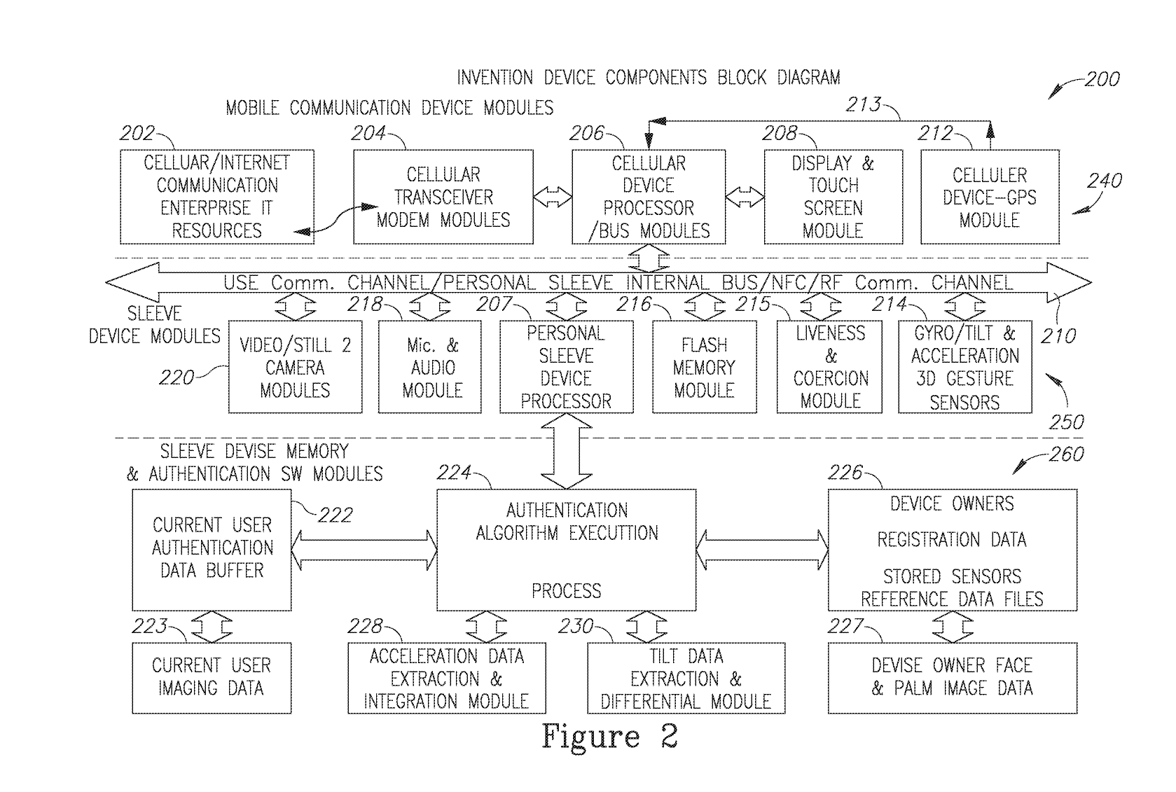

Reference is now made to FIG. 2, which is an illustration of an example of the present invention computerized secured mobile electronic; device hardware and software content and related configuration, according to one preferred embodiment of the present invention. Mobile personal electronic device 200 is representation of an exemplary present art mobile personal electronic device geared for serving as a single user to support the needs of secured and safe communication with the user automotive vehicle manufacturer enterprise servers and computerized resources. The device main use is in serving the user as a personal secured data depository, enabling large scale mobile data storage, secured data updating and data depository easy management. The device secured access is enabled through with a built-in user's bio authentication capabilities based on at least one device integrated biometric sensor output analysis of the user device holding person, done while the user is holding in his palm the invention integrated personal secured mobile electronic device 200.

The present invention integrated secured mobile device 200 may communicate through the cellular and internet communicating networks with a the user vehicle automotive enterprise IT resources 202 through the cellular wireless networks, as required to operate some of the dedicated functions related to the present invention mobile personal electronic device user's vehicular maintenance remote work related management functions. The invention integrated mobile device Cellular RF transceiver and Modem module 204 is representing the mobile device module that supports and enables the device data communication with the automotive enterprise IT center 202. The mobile communication device processor 206 is controlling the entire mobile communication device various functions of communication display and user's flat screen graphic management and processing capabilities. The electronic add-on sleeve/case 250 processor 207 is managing the sampling and the processing of the device movement sensors data and the imaging and voice sensors, as required to support the execution of user's authentication program module 224, based on the user gesture movements and voice analyzed reference enrollment stage recorded and stored reference data 230 and face and palm recorded reference imaging data 227, face and palm real time sampled images recognition measure data 223 and user's voice processing 218 sampled data. The display module 208 is a combination of a graphic/Image display screen and a touch sensitive screen to support the user's various interactions and the display of the interactions results with the invention secured mobile personal electronic device 200 through the modem of the mobile communication device 240.

The electronic sleeve/case shaped electronic device central internal data communication bus 210 is communicating between the mobile device and the invention sleeve/case device through the device 250 integrated USB hardware interface and through a NFC or other RF based wireless based short distance communication channel, combining together the described communication channel 210 operating within the add-on sleeve/case device 250, that supports the needs to transfer data and commands between the various modules of the invention integrated secured personal mobile device 200 combined of mobile device 240 and the invention mobile add-on sleeve/case 250. Module 220 is the mobile device add-on sleeve/case which has a resident internal still/video imaging module, 220 including one or preferably two or more electronic camera units, preferably equipped with aided LED visible and near infrared active illumination that support the best imaging condition of the device user face and/or palm, in order to document and authenticate the user according to his face and/or palm & fingers details pattern, all according to some embodiments of the present invention. Audio module 218 is including at least one microphone that enables the voice identification of the user as one of the selected biometric sensors required for the potential execution options of the user's authentication, based on the user voice personal characteristics analysis. Flash memory module 216 is at least one or more modules of solid state flash based memory modules resident within the electronic sleeve/case shaped add-on device 250 that holds the operational software of the sleeve/case shaped add-on device, as well as the functional software modules 222,224 and 226 that support the invention integrated secure mobile device 200 requirements to function as an isolated management secured communication and storage devise of the remote user and serving also as a secured data personal depository of a single owner user/employee to hold user's sensitive related encrypted data files. Liveness and Coercion related measurement and results analysis module 215 is serving as a measurement sensor to detect and measure several liveness parameters of the invention device holder and based on these measurement to decided if the device 200 holder is a live person and not a fake image deposited in front of one or two of the biometric cameras and also if the user is under a substantial emotional pressure, or is in a normal state of mind to avoid another person forcing the user to get access to the device stored sensitive data against the user's will. Tilt and acceleration 3D sensors module 214 is a unit resident within the invention integrated mobile device 200 electronic sleeve/case add-on sleeve/case device 250 that measures the linear acceleration on the three orthogonal axis of the device and the 3D tilt angles of the sleeve/case device 250 in space. GPS module 212 is another important built in sensor resident within the present invention mobile communication device 240, wherein the GPS world coordinated device dynamic position reading is fed through communication channel 213 to cellular device processor module 206 so to enable the allocation of the device in case of a user problematic medical or security threat situation emergency cases or if required for supervising of the employee location during work hours by his employee.

Authentication data buffer module 222 which is a part of the present invention electronic add-on sleeve/case device 250 memory and authentication sub-section 260, is a secured memory buffer containing the device biometric sensors initial enrollment stage sampled data of the mobile personal electronic device user's authentication reference data, as the stored digital converted output of the various sampled mobile electronic sleeve/case shaped device 250 resident biometric sensors, wherein the biometric data is collected and stored during the user first and initial enrollment registration process. The data buffer module 222 is also connected with sub-module 223 that samples and stores the current user face and palm images digitized data, to further use it as the users selectable additional channels of bio authentication sources, according to the present invention authentication embodiments. Module 224 is the central SW module; in the present invention electronic sleeve/case device 250 managing the selection of optimal process for selection, choosing and executing the optimal residing authentication algorithm, choosing the optimized one of several authentication algorithms and significant user identification sources options. The 224 module does the analysis the user's biometric sensors 220, 218, 230 and 227 modules output. The 224 module also creates the improved quality and reliability of the authentication process of the invention integrated secured mobile electronic device 200 while fusing together the user's measured biometric sensors output, wherein the method is implementing into the authentication process one or more of biometric data the user hand in air 3D gesture, the user's voice, the user's face pattern and the palm recognition imaging data, as the first, the second the third and the forth sources of the user's bio personal data, thus enabling an optimal quality authentication process, combining be selection any combination of the user's gesture, voice face and palm personal bio data.

Module 224 has in one of the invention embodiment another additional set of SW based group of functions 260 designed for execution in the cases that the authentication process of the current device holder is indicating a failure which is a non-authenticated user case. In such a case the module 224 is creating a series of preprogrammed alarm functions, creating audio alarm set of signals on the audio module 218 and displaying visual eye attracting flashing images through the display module 208. In parallel alarm data is sent from the invention mobile device to a remote cellular service provider and through it to a set of the users who are the device owner group of pre-selected piers to notify them on the event of theft or loss of said device 200 and the location of the theft, as it is constantly read and transmitted by the GPS module 212. Software module 226 is storing and managing legitimate user reference initial enrollment stage registration data, as required by present invention integrated mobile personal device 200, while managing the registration procedure of the legitimate user prepared and stored by module 226 to serve as the reference set of data while compared to the current user biologic sensors measured and processed authentication data. A sub module connected, functioning with and used by module 226. SW module 227 stores and manages the legitimate device owner face data including its face recognition parameters and also stores and manages the registered user's piers (friends and family) face recognition data to avoid false operation of the device alarm functions when one of the legitimate user's piers is by mistake lifting and holding the invention theft and loss protected mobile device. Module 228 is a SW module that manages the extraction of the sampled output of a set of sensors and also in processing integration algorithms on the acceleration measured device results data in order to achieve data related to the device velocity and position in space, based on the acceleration data one time and two times integration calculation results, Module 230 is a SW module that manages the extraction of the sampled gyro based tilt measurement 3D set of sensors and also in processing derivatives algorithms on the tilt angles measured device data results, in order to achieve data related to the device angular velocity and angular acceleration in space, based on the measured 3D tilt angles data, one time and two times derivatives calculation results,

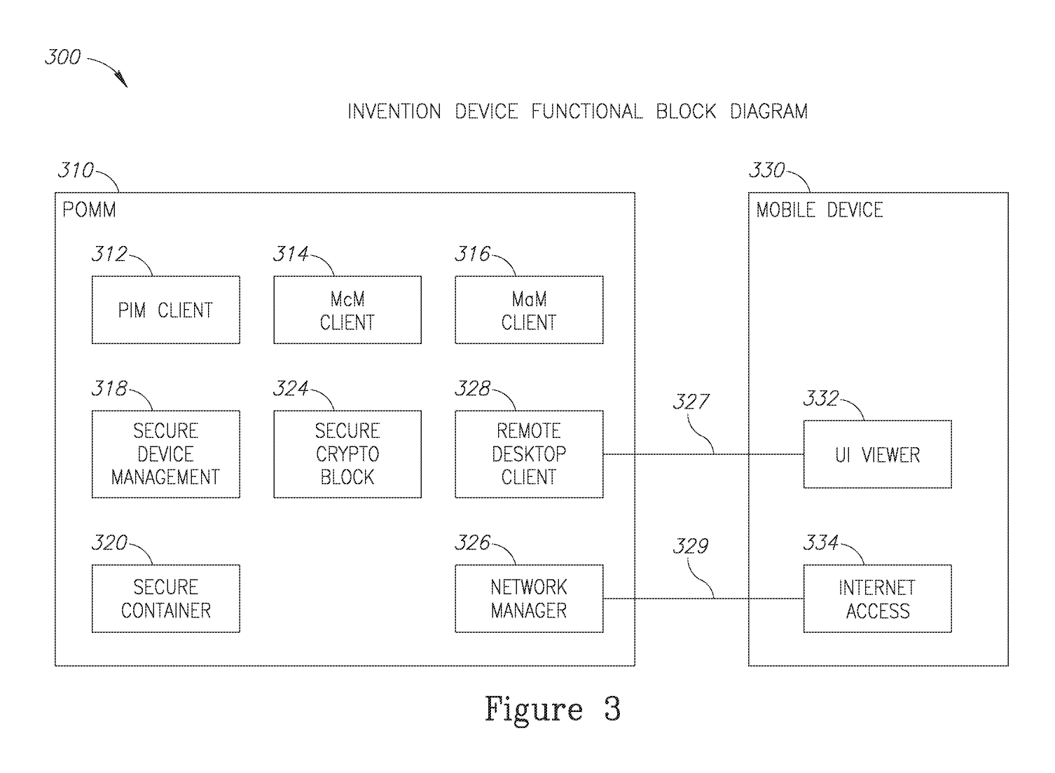

Reference is now made to FIG. 3, which is a schematic illustration of the present invention integrated mobile secured personal electronic device 300 combined of a mobile computerized communication device 330 and the invention second part of an electronic add-on sleeve/case 310. The figure demonstrates the functional modules residing on each of the two present invention integrated device components 310 and 330.

The electronic sleeve/case add-on device 310 Secure Device Management module 318, located in the invention electronic sleeve/case add-on device 310 is responsible to communicate with enterprise MDM Server component on the automotive enterprise network and perform the required function. The electronic sleeve/case add-on device 310 management functions includes: 1. Online monitoring of the MDM server of all MDM clients that currently connected with devices 300. 2. Enforcing remote wipe of locking for compromised devices 300. 3. Logging of user action on the electronic sleeve/case add-on device 310 by the MDM client 314 and sending periodic reports to MDM server.

The invention electronic sleeve/case 310 device interacts with the mobile device 330 with two channels 327 and 329: 1. Remote desktop client module 328 is interacting with the mobile device 330 Dl Viewer 332 through UI Channel 327; and 2. Network channel 329 is interacting between the module Network Manager 326 residing on the invention sleeve/case device 310 and the Internet Access module 334, residing on the Mobile, device 330. In the UI channel 328 the mobile is acting as a remote viewer 332 to the invention electronic sleeve/case 310, enabling the user to interact with invention electronic sleeve/case 310 through the UI Remote Desktop Client module 328. Through the network channel 329 the mobile 330 is acting as a cellular modem and internet access gate 334 to the invention electronic sleeve/case 310, enabling network communication with the automotive enterprise remote servers.

In the invention device 300 Enrollment Process, this is a process in which the enterprise system is registering the invention device in order to identify the access request from the invention device. This process is done by Enrolment Server which includes all necessary invention device private and public keys.

The enrollment is done by connecting the invention device 300 physically to the Server with USB connector. The enrollment process includes key provisioning for the invention device 300, as well as biometric enrollment of the employee.

The invention add-on sleeve/case device within the 310 Secure Device Management module 318 located in the invention device 300 is responsible to communicate with MDM Server component on the enterprise network and perform the required functions.

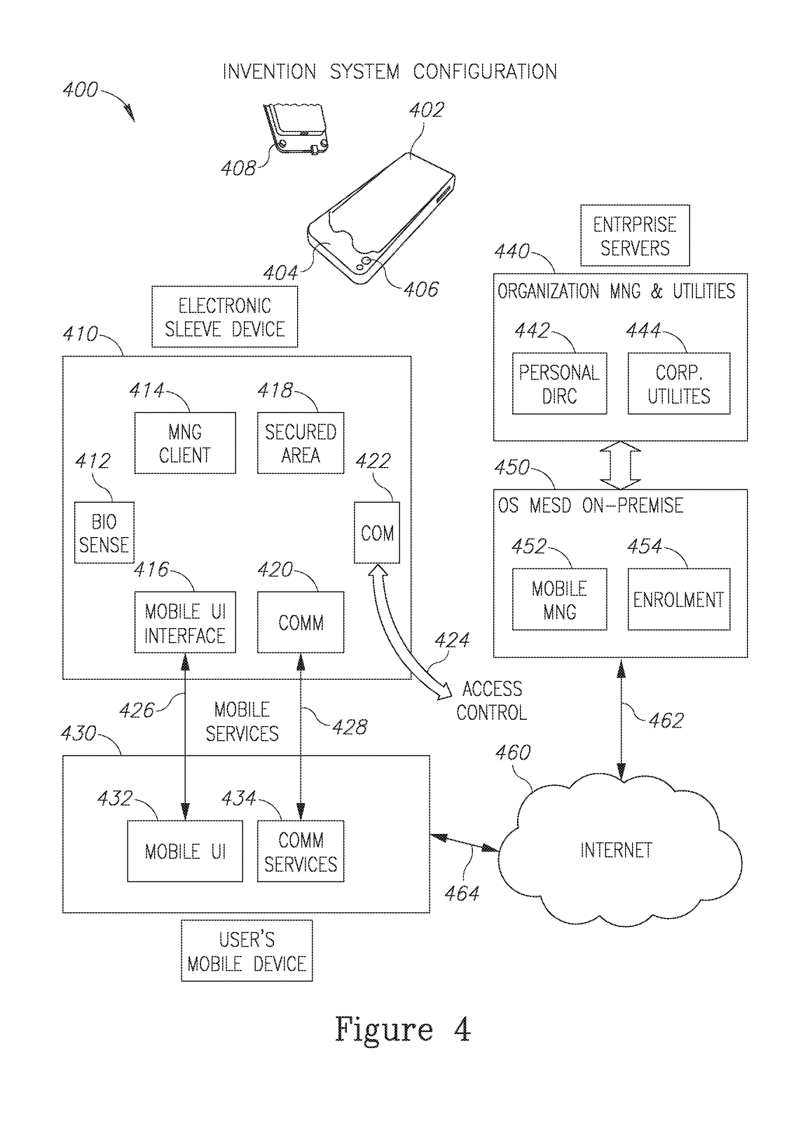

Reference is now made to FIG. 4, which is an illustration of an example of a computerized enhanced local and remote enterprise secured data management system 400, according to one embodiment the present invention system.

The schematic illustration shows another preferred embodiment the invention main functional modules combining and physically connected, thus creating the user's invention integrated mobile personal electronic device 402 combined of the user mobile device 402 and the invention electronic add-on sleeve/case 404. This combined device 406 is connecting through the cellular and Internet managed cloud to the user employer IT management infrastructure.

The invention add-on sleeve/case device 410 is including the user's authentication oriented biosensing module 412, the device client data processing and management module 414 based on the internal integrated powerful CPU. Secured area 418 includes a security protected area for storage of sensitive files of the user employer enterprise proprietary data. Communication unit 420 includes hardware based USB communication capability 428, as well as a NFC and/or Bluetooth short distance communication capability 426 to transfer secured data files between the mobile device 430 and the present invention add-on electronic sleeve/case device 410, physically attached as a binding sleeve/case to the user smartphone unit. The sleeve/case device 410 as a built-in NFC unit 422 that enables it to connect from short distances with kiosks, ATMs or PCS that enable device 410 to download data from external terminals.

The invention new device is including in it a mobile device 430 that includes in it a communication management subunit 432 that creates and is in charge of the wireless communication between the mobile device 430 and invention electronic sleeve/case 410.

The invention mobile device 430 is connecting through link 464, based on its integral cellular communication modem and communication means 434, to the internet 460, supporting internet/cloud communication for the long distances that are typically required for the remote user/employee hand held device communication device connect to the IT infrastructure supported by the employer IT resources 450. Remote Enterprise BYOD application management requires supporting servers included in units 450 and 440. To let the enterprise servers to recognize the legitimate enterprise worker/user personal device, the employers servers are first conducting a user enrollment procedure, so there is a first access enrollment server 454. Mobile Management Server 452 is in charge of communication management with all the multiple employees BYOD devices. Enterprise servers unit 440 includes in it also the personal directory server 442 managing the data flow and transfer between the remote users using their personal devices and the automotive remote enterprise IT resources. Corporate utilities server 444 manages a plurality of remote access services to the users, such as mail and corporate directories and internal enterprise management resources.

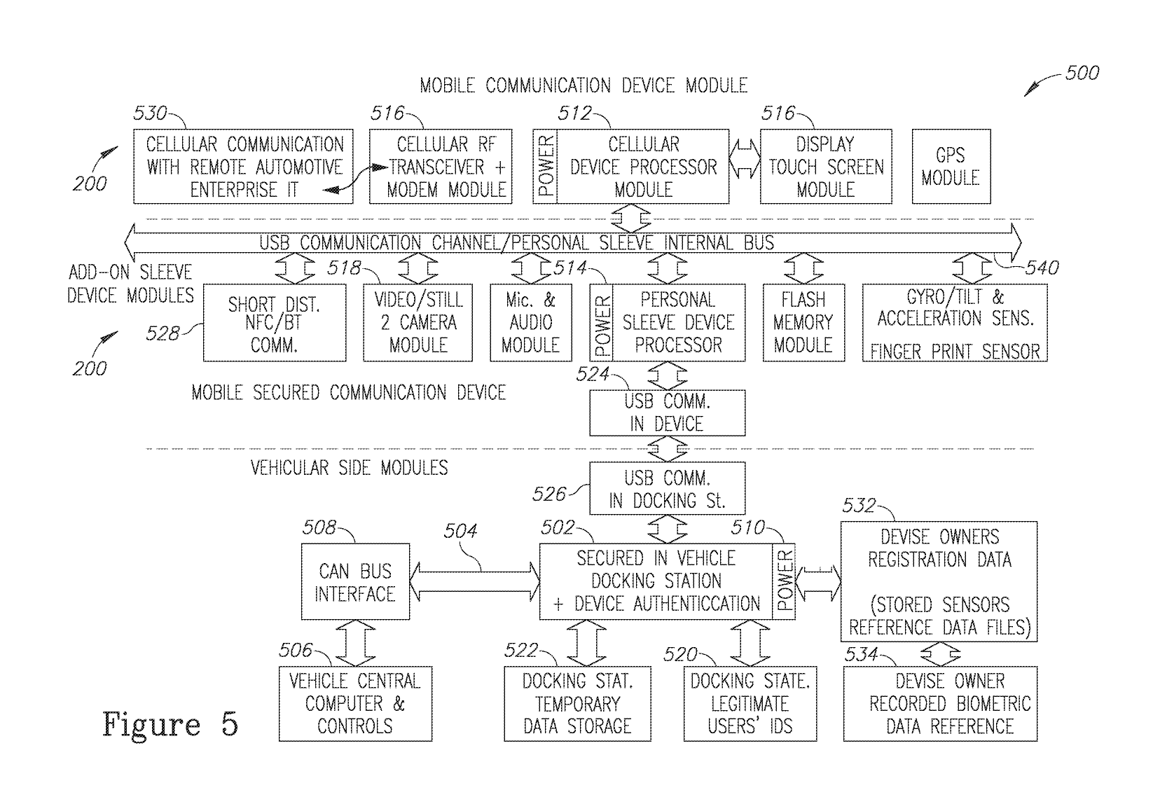

Reference is now made to FIG. 5. This is a schematic block diagram illustration of another possible embodiment of the present invention related to the use of the invention secured mobile devise 200 for automotive vehicle advanced management related functions and their actual implementation execution and management, wherein the invention secured mobile device 200 is used for a multiple functions in vehicular electronic data management system 500 implementation. The system 500 is serving the needs of advanced vehicular control and management functions with higher security management, better vehicular operation management and remote service optimization and ease of use of the vehicle, thus supporting the modernization of the modern automotive and cars industry. For this system 500 embodiment and the invention device 200 integration to the vehicle, it is also needed to have an additional special in-vehicle anchoring smart and secured docking station module 502. The secured docking station module 502 is added and installed to the car dashboard, or into the driver's car front control panel, while serving the need of functioning as the user's invention 200 combined smartphone 530 and sleeve/case device 540 executing the legitimate car owner/driver authentication generated function and for enabling the hardwired 504 secured communication solution with the car computing and control integral modules 506 connecting through the vehicle internal data CAN bus 508 and alike. In parallel, the present invention .automotive related system embodiment the 500 smart docking station 502 will be serving also as a power charger 510 for the present invention combined mobile device sleeve/case and smartphone separated power charging and power storage integrated units 512,514.

This invention embodiment 500 may have three variant solutions to serve various types and different needs of the vehicle driver's integrations with the vehicle, covering three different operational requirements: 1. Each car can have several authorized different drivers 2. The car belongs to a company that has one or more authorized vehicle fleet management officers. 3. The car belongs to a Rental Company, with different levels of use permissions to the authorized rented vehicles fleet management officers and the clients renting the cars for a limited time period.

The present proposed system embodiment 500 can function and further contribute to the vehicular industries electronic modernizations, ease of vehicle use and improved security management, in 3 different operational functional routes:

1. To open the car doors—for these functions the invention device needs to implement and operate the NFC or alternatively the Bluetooth electronic wireless communication module 528 integrated inside the invention device 200 sleeve/case unit 540 to enable remote contactless opening/closing of the vehicle doors. The user first opens the data communication capabilities of the invention secured mobile device 200 by pressing on the dedicated secured automotive management application activation icon soft button on the device 200 integrated smartphone touch screen 516. To authenticate himself the vehicle user operates one of the biometric authentication sensors based modules integrated in the invention secured mobile device. For the sake of the .authentication method description in here in order to demonstrate the concept, the user creates a video image of his face through the invention device integrated biometric camera sensors, in order to enable the creation of a face recognition photo-image, then further executing legitimate vehicle owner biometric authentication. At the following step the user presses the car-open soft button in the invention device smartphone display module 516 menu. The car code is then transferred to the car locking system wireless receivers through the invention device integrated NFC/Bluetooth wireless communication module 528, while using the device integrated communication antenna and then the vehicle doors are electronically opened. A similar set of acts, operated by the user with pressing additional dedicated soft buttons on the smartphone display module 516, can enable the secured vehicle oil tank cover opening/closing and the vehicle motor compartment cover opening. All the above detailed special security and privacy vehicle protection upgrading features support a higher level of vehicle protection against theft and misuse of the protected vehicle.

2. To restart the vehicle motor/engine—Using the invention device 200 another preferred mode of its use embodiment, it may be done through the device 200 described automotive integrated secured smart docking station 502 unit, while the invention device 200 is inserted into the present invention embodiment smart docking station 502 that is integrated in the vehicle dashboard or driver's front panel. When the driver inserts the invention device 200 into this car secured docking station 502 and presses another dedicated graphic soft button in the invention device 200 integrated smartphone 516 graphic display menu: a driver face image is then automatically photographed by the invention device 200 integrated camera 518, as needed to execute the legitimate driver biometric authentication. The driver may select another biometric authentication channel to be authenticated, selected from the group of biometric sensors integrated into the invention secure mobile device, Following the positive user's face recognition biometric authentication step, the vehicle motor will then automatically electronically restart. Alternatively, there is another soft button in the invention device 200 mobile display 516 menu, that is pressed by the driver to execute a following step of enabling a secured manual car motor restart and then the car motor will restart. The detailed special security and privacy level in the invention vehicle ignition advanced features support a higher level of protection of the vehicle against theft and the misuse of the protected vehicle.

The above described invention device 200 smart docking station 502 in the vehicle will have the possibility to recognize and register the device 200 ID number and passwords stored in unit 532 derived from one or more pre registered main vehicle approve drivers devices 200. The main limited number of authorized vehicle drivers can self-register an additional number of temporary approved drivers under their supervision, done by and through the smart docking station 502, only after users are being self-authenticated by theft mobile devices 200. It is done by legitimate registered users are inserting into the secured docking station 502 the invention device 200, while station 502 is authenticating their IDs and then identifying and creating legitimacy for an additional number of temporary active tokens fitted to be inserted to same docking station 502. These tokens are supplied to the temporary registered additional drivers. The same way the legitimate authorized vehicle drivers can also delete or update the authorized temporary driver's tokens legitimacy, when needed. It is to be understood that each driver needs to first register his invention device 200 ID number and passwords in the car integrated smart docking station 502 memory. Without this preliminary car registration acts execution at the smart docking station 502 memory unit 520, the car will not restart or function for any user either the docking station 502 is inserted with a registered invention mobile device 200, or a temporary user accessing the car with a dedicated token.

3. To change and update new SW and vehicle maintenance history data versions for executing the technical data updating interactions needed with the car computers and controllers. The present invention embodiment suggests two different alternatives to do this SW and data updates; a. The vehicle manufacturer, upon user's identified legitimate request, will send to the invention device 200 secured memory, received through his attached cell phone 516 communication modem, with a new version of the car computer SW operational system while being encrypted. The main group on the vehicle authorized drivers will be the only ones that will get this updated car SW operational version and only one of them will be allowed to change the in vehicle computer 506 installed SW in practice. The SW and data updating will be done only following the connection of the invention device 200 to the docking station 502 and then after the authorized vehicle driver being positively authenticated. The vehicle manufacturer will send through the mobile device 516 cellular modem data communication capabilities the new encrypted SW version to be temporarily stored on the smart docking station 502 controller memory itself 522. The group of the vehicle main authorized drivers can open the file with their special keys stored within their present invention devices 200 secured memory or within the docking system 502 secured ID memory unit 520, that operation will be executed in practice while the authorized vehicle drivers connecting their integrated Invention secured mobile device 200 to the car smart secured docking station 502.

The present invention dedicated device vehicular smart docking station 502, is planned to be an integral part of each new car, or installed in excising cars by qualified technicians. In practice while inserting the invention integrated secured mobile device 200 into the invention docking station 502 the driver will connect the device 200 internal USB connecting element 524 (or a similar miniature matching connector) into the mating USB 526 (or a similar miniature matching connector) positioned at the bottom end of the smart docking station 502 recess. This vehicle smart docking station 502, which is a part of this invention embodiment, will serve also as the electronic secured interface mediator between the car computer 506 and the present invention secured mobile device 200. Each driver needs to register his present invention secured mobile device 200 in this car smart docking station 502 to exchange and store passwords and the device singular ID serial number at the smart docking station 502 internal secured memory module 520. It is possible that the generation of the individual passwords will be done in the present invention smart docking station 502 itself, while the car details and codes will be transferred to the invention secured mobile device 200 by a special application, When a person buys a car he/she needs to create initial passwords in the vehicle company and to register it to the secured memory module 520 of docking station 502 inside the car. It is logical that the main drivers will be the car owners, or the vehicle fleet officer, or the rental cars employees. In order to reset all the drivers IDs from the memory unit 520 of the smart docking station 502 memory, only one of the main drivers may be able and authorized by the car security system to do it.

What is claimed is:

1. An integrated secured personal mobile electronic device communicating, storing managing and updating all user's private life daily privacy sensitive data or private sensitive operations, comprising:
a) a mobile communication device equipped with a CPU, a display unit, one or more biometric sensors, a rechargeable power battery module and a cellular modem to enable data communication over the cellular and internet networks equipped to receive and send user's private data with a plurality of data sources;
b) an electronic physical protection sleeve/case shaped as an add-on device, attached and fits to said mobile communication device external back side perimeter, to create together with said communication device a unified user carried single device, said sleeve/case contains at least one CPU, a solid state large storage capacity secured memory module equipped to encrypt/decrypt, store and manage said user's private and personal data, said mobile secured communication device also containing a biometric sensors module, a RAM unit, a rechargeable power supply battery module and data communication wired and wireless means to enable connection and data exchange between said mobile communication device and said electronic sleeve/case;
c) wherein; said add-on device biometric sensors module comprised of a set of at least one biometric measuring parameter sensor, each of said at least one sensors is measuring and generating a different user's characterizing biometric parameter;
d) wherein in response to the measured output of any combination of said add-on sleeve/case biometric sensors module and one or more biometric sensors of said mobile communication device user's personal measured and sampled biometric output signal, a user's authentication analysis process is executed by at least one of said integrated secured mobile personal electronic device CPU units, while said user's authentication is based on said at least one user's measured biologic sensors output signal processing results and their comparison to the reference pre-recorded securely stored user's measured biologic sensors initial device enrollment stage measurement output; and
e. only when such authentication process results are positive said add-on secured electronic sleeve/case is creating a direct two-way secured data communication and data exchange channel with said mobile communication device.

2. The integrated mobile personal electronic device of claim 1, wherein:
a) a set of user's private data management related functions activation and operation is executed when a user sampled biometric data sequence of said user measured at least one biometric parameter is compared for good matching by said add-on sleeve/case CPU to similar prerecorded and stored data on said sleeve/case memory containing a set of sampled device reference legitimate registered user's biometric initial enrollment stage measured data;
b) wherein said prerecorded sampled biometric reference data is recorded upon the legitimate user executing on said mobile electronic device an initial supervisor controlled registration enrollment procedure, enabled by said at least one biometric sensors output while being recorded and securely stored on said electronic sleeve/case memory for further authentications;
c) wherein said related set of users private data management functions is positively activated and said device sleeve/case secured memory is unlocked and ready for use, only for a pre-defined time duration when said electronic sleeve/case operated by a legitimate mobile device user is activating said at least one measured user's biometric sensors and said at least new sensor output data is being positively compared with said legitimate user pre-recorded registration procedure reference data, and said two sets of sensors' output data deviates from each other by less than a predetermined minimal threshold; and
d) wherein said mobile personal electronic device further containing a touch screen display unit for display of data to the user and indicating said device status and for the user's interaction with data content of said mobile electronic device communicating with said user remote data suppliers.

3. The integrated mobile personal electronic device according to claim 1, wherein at least one of said at least one biometric sensors is a life signs detector, said life signs detector being configured to measure and record at least one of said user's life sign parameters.

4. The integrated mobile personal electronic device of claim 1, wherein said at least two measuring biological sensors are selected from two sensors group including one sensor selected from the first group comprising from at least: a three dimensional device air-gesture linear acceleration based measuring sensor, a three dimensional mobile device air-gesture angular movement tilt measuring sensor, a fingerprint pattern sensor, a face recognition imaging sensor, a palm pattern and morphology and palm veins IR imaged veins networks combined measuring and analysis IR/visible imaging sensor, user's voice analysis based on a voice pickup microphone sensor and a second sensors group comprising of at least one user's life signs indicating sensor selected from the physiological parameters measuring sensors group comprising of at least the user's heart bit rate, blood oxygen content, body temperature, EKG and user's skin conductance.

5. The integrated mobile personal electronic device of claim 2, wherein the digital output of one of said at least one biometric sensors user's biological parameter measurement results and said measured at least one additional biometric sensor output results, are fused together by using a learning and adaptable dynamically weighted factor fusion algorithm, done between said two sensors measured output, in order to enable improved and precise analysis and identification of the legitimate user exact typical personal characteristics. and wherein said algorithm is creating a highly reliable user's authentication mechanism to best decide, while comparing to a similar reference initial enrollment stage prerecorded fused set of said two kinds of sampled user's biometric sensors, if to activate said internal sleeve/case operation for enabling user's access to said sleeve/case secured memory content.

6. The integrated mobile secured personal electronic device of claim 2, wherein:
a) said secured mobile device further comprises a biometric data processing module for processing the output of said first and a second biometric sensors; and
b) wherein said mobile device further comprising a database management software module to manage the user data records stored in said mobile device sleeve/case solid state large capacity secured memory, related data records are database managed to enable said device user quick and easy filing and retrieval of specific data records files.

7. The integrated mobile personal electronic device of claim 2, further comprising;
a) a dedicated encryption module within said electronic sleeve/case, said encryption module resides within said sleeve/case CPU secured zone and is used to encrypt and decrypt said data content of said user work enterprise data records stored encrypted in said mobile device sleeve/case; and
b) wherein the encrypted data of said at least one biometric sensors pre-recorded registration procedure reference generated data is being recorded and stored during user's initial enrollment stage for further authentications as the biometric sensors output based registered user authentication reference data.

8. The integrated personal mobile electronic device according to claim 1,
wherein said at least one of biometric sensors output continuously read and produce a plurality of personal biological identification associated output parameters associated with said user holding the integrated personal electronic device; and
In the event that a noticeable change occurs in any of said measured personal biological identification parameters, then access to said stored user work enterprise data files is denied and the operation of said electronic sleeve/case device is completely shut down while the operation of said mobile communication device is still intact.

9. The integrated mobile personal electronic device according to claim 3, wherein said at least one of said user's life sign parameters is measured by one or more sensors selected from the group of life sign indicators and sensors, including; a heart bit rate measurement indicator, a blood O₂ saturation level indicator, a body heat measurement indicator, an electro-dermal conductivity activity indicator, a body respiration indicator and a physical or emotional stress coercion sensing measurement indicator.

10. The integrated mobile personal electronic device according to claim 9, wherein, whenever any of its at least one life sign indicators detects a pre-defined critical level, said mobile electronic device is configured to initiate an emergency call to at least one entity selected from a group of the user's memory stored emergency security management units, or remote emergency medical centers and then said mobile electronic device sending a group of data files containing emergency case management information associated with the user, including the personal identification data file of the user, personal emergency situation related to the stored medical data file of said user, the recently measured set of life sign parameters of said mobile electronic device user and the location of the user.

11. The integrated secured personal mobile electronic device of claim 1, further adapted to user operation with said device in a user associated vehicle environment for enabling and supporting the technical needs of secured communication from said device to said user vehicle integrated automotive computer and said electronic control units and in parallel enabling secured data communication with said vehicle remote automotive enterprise IT resources, said user associated vehicle environment further comprising;
a) an additional special in-vehicle electronic smart docking station adapted for operating with said invention secured personal mobile electronic device by its insertion into said car anchoring secured docking station module, said docking station mechanically integrated with or into the vehicle dashboard or to the vehicle deriver's control panel;
b) said vehicle integrated secured docking station acting a s security smart electronic data buffer between said user secured personal mobile device and said user vehicle computer and vehicular electronic control modules;
c) upon positive authentication of the legitimate vehicle user by said secured personal mobile electronic device authentication module, only then data received from remote legitimate authenticated vehicle maintenance data resources and stored on said secured docking station memory module is then released for use by said smart docking station and transferred and exchanged through said vehicle integrated vehicular data bus with said vehicle computer and electronic control modules;
d) upon positive authentication of the legitimate vehicle user by said secured personal mobile electronic device integral authentication module, only then data is received from, or transmitted to, between said personal mobile electronic device and said remote automotive enterprise IT resources all done through the data transfer security assurance control of said intermediate secured docking station; and
e) said secured docking station serving in parallel as the battery charging power source for the two batteries modules integrated in both said communication device and said add-on invention smart sleeve/case.

12. The integrated mobile personal electronic device of claim 5, wherein a access to user's vehicle remote automotive enterprise IT resources, or to enable the internal operation of one or more user automotive operation related interaction functions are combined with said secured mobile electronic device dual biometric channels authentication including the one or more of the automotive protected operations enabled by said electronic secured device opening the vehicle doors, ignition of the vehicle motor, opening/closing of the vehicle gas lead for fueling and opening of the vehicle engine compartment lead cover.

13. The integrated secured personal mobile electronic device of claim 11, wherein following the positive authentication of the legitimate vehicle user by said secured personal mobile electronic device integral authentication module, the user can open the vehicle doors by pressing a soft button on said secured mobile touch screen display then activating the car electronic locks through the wireless communication module integrated into said mobile electronic device.

14. The integrated secured personal mobile electronic device of claim 11, wherein only following the positive authentication of the legitimate vehicle user by said secured personal mobile electronic device integral authentication module, the user can insert said secured personal mobile device into said smart docking station and after his device being recognized by said docking station and getting legitimate user positive authentication confirmation, the user can select to activate one or more of the following functions:
a. ignite the vehicle motor by pressing vehicle a second soft button generated on said device touch screen display;
b. open the vehicle gas fueling insert cover by pressing a third soft button generated on said device touch screen display;
c. open the vehicle engine compartment cover by pressing vehicle a fourth soft button generated on said device touch screen display.

15. A method for user interacting managing and updating data and associated documentation exchange for enabling user's local work with said user stored data resources said user having an integrated mobile personal electronic device including mobile communication means and an electronic sleeve/case shape add-on device uniquely associated with its said single user, each of said integrated personal mobile electronic devices comprising:
a. a mobile communication device equipped with a touch screen for user's interaction and a cellular modem to enable data communication over the cellular and internet networks equipped to receive and send user's vehicle related data to and from the user vehicle manufacturing enterprise IT management resources; and
b. an electronic secured sleeve/case shaped as an add-on device, attached and fits to said mobile communication device external back side perimeter to create together with said communication device a unified user-carried single compact device, wherein said electronic sleeve/case contains:
a biometric sensors module comprising at least one biometric set of sensors;
a processing CPU module in communication with said sensor module;
an authentication unit in communication with said CPU based processing module;
an encryption module in communication with said processing module;
a memory module in communication with said processing module and with said encryption module; and
communication and data connection means in communication with said mobile communication device.
the method comprising the steps of:
a. said electronic sleeve/case biometric sensor module reading said at least one personal biological identification sensors output parameters of a user holding said mobile communication device;
b. said electronic sleeve/case biometric sensor authentication module comparing the generated personal biological identification parameters of said user with a pre-recorded set of personal biological identification parameters stored in said electronic sleeve/case authentication unit; and
c. if said authentication unit positively identifies said user, then allowing said user to get access to said user's personal data documentation and work files stored in said electronic sleeve/case memory module for is management updating and review and when required also allowing user during said user pre defined access allowance time duration to communicate and exchange files and data with the user's vehicle automotive enterprise IT requested or needed resources through said mobile electronic device communication capabilities.

16. The method of claim 15, further comprising the additional steps of:
a) said at least one biometric sensors continuously reading said at least one personal biological identification parameters of said user while holding said mobile personal electronic device; and
b) in the event that a change occurs in any one of the measured at least one personal biological identification parameters, denying user access to said sleeve/case stored secured data files and completely shutting down said electronic sleeve/case internal secured memory stored, data access and data exchange operational capability of said user with said remote employer enterprise IT resources of said user.

17. The method of claim 15, wherein at least one of at least two biometric sensors is a life signs detector, configured to measure and record at least one of a group of life sign indicators including a heart pulse rate measurement indicator, a blood O₂ saturation level indicator, a body heat measurement indicator, an electro-dermal activity indicator, a body respiration indicator and a physical or emotional stress coercion indicator, the method further comprising the steps of:
a) initiating an emergency call to at least one emergency center wherein said center details and communication data are registered and stored in said mobile device electronic sleeve/case memory, whenever any of the user's measured life sign indicators detects a critical abnormal level; and
b) wherein said emergency call transmits a selected medical emergency related data file of medical and personal information associated with the user, including identification of the user, personal emergency medical data file of the user, including the measured set of life sign parameters of said user and the measured location of said user.

18. The method of claim 15, wherein said integrated mobile personal electronic device further comprises an emergency button, selected from the group comprising a software generated soft button and a hardware button, said button in communication with said processing module and said communication and data connection means, the method further comprising the steps of:
a. when said emergency button is activated, communication is initiated between said mobile personal device and at least one registered emergency mobile service or emergency center; and
b. said emergency communication transmitting a emergency data file with information associated with the user, including identification of the user, the updated personal emergency medical data file of said user, and location of said user.

19. A multi user vehicular digital multi functions management system, said system combined of a plurality of remotely distributed users' owned controlled & integrated said secured mobile personal devices, each said secure mobile personal device containing a secured vehicular user's vehicle maintenance related management data module, each said integrated mobile personal device constructed of a combined mobile communication device together with an attached mobile electronic add-on sleeve/case device, said sleeve/case functioning as a private user bio-authentication and enterprise secured data communication and related vehicle maintenance records files storage and management platform, said system comprising:
a. a system gateway server operating as said system manager for managing and updating communication addressing ID data of said system plurality of remote vehicular management users private secured mobile devices and for securely communication between each of said plurality of said vehicular remote mobile devices with the vehicular automotive enterprise IT resources.
b. a memory sub-system connected to said system gateway server to store updated ID data of said mobile devices and any required associated vehicle data of each of said plurality of said mobile devices vehicular users;
c. a plurality of personal mobile devices units, each of said mobile devices being associated with a unique user, each unique ID data of said mobile devices being registered with said system gateway server and wherein the ID data file of each unique vehicular ID data of said mobile devices being stored in said memory sub-system;
d. wherein said gateway server enables access and creates a communication link with the any of said system registered users through their said private mobile devices containing said user's related vehicular management data and documentation files; and
e. wherein said access to any user's requested said device stored vehicular maintenance related data and associated documentation files and two way data communication with said user vehicle remote automotive enterprise IT data resources is only enabled after positive authentication of said unique legitimate vehicle user's enabled only by said user mobile personal mobile device.

20. The multi user's remote vehicular enterprise interaction functions management system of claim 16, wherein each of said plurality of said integrated personal mobile devices units comprises:
a. a mobile computerized communication device such as a smartphone or a notepad having an internal communication modem enabling data communication through the cellular networks and internet infrastructure and having one or more biometric sensors and a touch screen for user's interaction with said communication device; and
b. a mobile electronic sleeve/case device, said sleeve/case functioning as a private user bio-authentication and enterprise related vehicular management records files secured storage and management platform physically attached and electronically interconnected with said communication device, wherein said mobile electronic sleeve/case device further comprising;
i. a sensor module comprising a one or more of a plurality of biometric sensors for reading at least one personal biological identification parameters of the user holding the of personal identification unit, said personal identification unit being uniquely identified with said user;
ii. a processing module in communication with said sensor module and said one or more biometric sensors on said communication device for processing said personal biological identification parameters and for processing and managing the personal and secured data and vehicular documentation files associated with said user interactions with said automotive enterprise ;
iii. an authentication unit in communication with the processing module configured to receive and authenticate the identity of said user by comparing said user's personal biological identification parameters read by said sensor module and by said sensors in the mobile communication device and processed by said processing module, with a pre-recorded initial user's and device enrollment set of personal biological identification parameters stored in said authentication unit;
iv. an encryption module in communication with said processing module for said encryption plus compression and/or decompression plus decryption of said user's data files;
v. a memory module in communication with said processing module and said encryption module for the storage and management of said user's vehicle maintenance related data and documentation files; and
vi. communication and data connection means in communication with said processing module for connecting said personal mobile device units with said system gateway server and through said server with said automotive enterprise IT resources.
